(19) United States
(12) Patent Application Publication
(10) Pub. No.: US 2015/0095151 A1
(43) Pub. Date: Apr. 2, 2015

(54) Friend Resource Network

(71) Applicants: George Kanattu, Wayne, NJ (US); Jayan M Joseph, Hillsborough, NJ (US)

(72) Inventors: George Kanattu, Wayne, NJ (US); Jayan M Joseph, Hillsborough, NJ (US)

(21) Appl. No.: 14/502,667

(22) Filed: Sep. 30, 2014

Related U.S. Application Data
(60) Provisional application No. 61/884,383, filed on Sep. 30, 2013.

(51) Int. Cl. G06Q 30/02; G06Q 50/00

(52) U.S. Cl. CPC G06Q 30/0255; G06Q 50/01
USPC 705/14.53

(57) ABSTRACT

A system and method for sharing resources through a user interface such as a website or a smart-phone application, wherein a plurality of previously-registered accounts is connected to a plurality of resource accounts through an endorsement process. A user account can connect to a plurality of social media accounts to connect to the trustworthy individuals. As a result, the user account has a leveraged social media network that includes trustworthy users. Since, endorsement data of the users of the plurality of social media account holders is displayed, the user account is guaranteed to receive accurate information regarding a product or service. The endorsement process connects the user account and a specific resource account on a common platform. As a result, the specific resource account can directly communicate with the user account.

The current application claims a priority to the U.S. Provisional Patent application Ser. No. 61/884,383 filed on Sep. 30, 2013.

### FIELD OF THE INVENTION

The present invention relates generally to the field of online reviews. More specifically, the present invention is a software system and method that can be used to enhance the local economy by sharing a user's resources within a social network setup. The present invention builds upon the traditional method of spreading information through the word-of-mouth.

### BACKGROUND OF THE INVENTION

Advertising is a key factor that determines the growth of a product or service. Throughout history, various methods of advertising have been utilized by business owners. Television commercials, radio commercials, and newspaper advertisements are among the most effective advertisement methods. The main reason for these methods to be successful is due to the ability of addressing a large number of people within a limited time period. These mentioned advertisements promote the business owner among other competitors in order to gather more customers. However, the quality of their product or service can be determined only after purchasing the product or service. The lack of information to determine the quality of a product or service prior to purchase can be disadvantageous. This is especially true, when the product or service is unsatisfactory compared to other products or services available in the market.

Prior to advanced communication methods, information regarding a certain product or service was conveyed to another individual through word of mouth. Word of mouth can be especially beneficial if a certain product or service is unsatisfactory. However, since word of mouth only conveys information within a small network of individuals, the extent to which the information is circulated is limited.

As seen on many occasions, the increased competition in a given field of business has lowered the quality of products and services. The poor quality of service has resulted in an increase in the number of unsatisfied customers. Resultantly, the need for a convenient method of conveying firsthand experience regarding a product or service was clearly evident. In order to fulfill the need, online review systems were introduced. With the increase in internet usage, these online review systems are considered a great asset. However, they tend to have some major flaws that need to be addressed immediately.

One of the major flaws of online review systems is the alarming increase in the number of false reviews. Most companies pay certain individuals to post positive reviews with the expectation of concealing any negative reviews. The positive, but yet false reviews mislead a potential customer, who ultimately gets to know the true nature of the product or service only after purchase.

Another flaw with the existing online review systems is the presence of a wide range of reviews. More specifically, reviewers post an online review for different aspects of the product or service. Most importantly, these negative reviews or positive reviews both similarly contribute to the overall rating, which is the final judging factor of a product or service. For instance, consider a negative review posted for a local small business service. The negative review can be due to the neighborhood that the local small business service is located in. However, a potential customer may not be concerned about the neighborhood that the local small business service is located in, but only about the quality of service provided by the local small business service. In such instances, the posted online review is not entirely helpful to the potential customer. Since online reviews are posted by unknown individuals, the potential customer has to be satisfied with the provided information. More specifically, the existing online review systems limit the potential customer from contacting a reviewer.

Another disadvantage with the existing online review systems is the expense that is involved in order to use them. For instance, most online review systems require the user to pay a certain premium amount in order to view and also post reviews regarding a certain product. In these paid online review systems, only a limited number of reviews are displayed free of charge. Therefore, there is a possibility for a customer to be misled by viewing only the free reviews.

The objective of the present invention is to address the aforementioned issues. In particular, the present invention is a system and method that can be used to gather valuable information regarding certain products or services. In order to do so, the present invention utilizes the existing social networks of a potential customer. More specifically, the present invention allows the potential customer to view reviews made by other individuals within their existing social networks. As a result, the potential customer can utilize a desired product or service based on their trustworthy reviews. In particular, the present invention leverages the effectiveness of transferring a message through word-of-mouth by using digital media. Furthermore, the customer can endorse a product or service and communicate directly with them through the present invention. The direct communication is useful to the service provider to get more customers and also for the customer to get a better service. By utilizing the present invention, customers can be guaranteed to receive good services from a variety of products and services.

### BRIEF DESCRIPTION OF THE DRAWINGS

FIG. 1 is a system overview of the present invention, wherein the thick solid lines represent the resources endorsed by a previously-registered account, the thin solid lines represent the connection in-between the previously registered-accounts, and the dotted lines represent the endorsement data that is visible to a previously-registered account.

FIG. 2 is a flowchart illustrating the process of linking a plurality of social media accounts in the present invention.

FIG. 3 is a flowchart illustrating the process of connecting to a specific resource account in the present invention.

FIG. 4 is a flowchart illustrating the process of connecting to a non-mutual account in the present invention.

FIG. 5 is a flowchart illustrating the authentication process of the present invention.

FIG. 6 is a flowchart illustrating the query process of the present invention.

FIG. 7 is an overall flowchart illustrating the user account endorsing the specific resource account in the present invention.

### DETAIL DESCRIPTIONS OF THE INVENTION

### Terminology and Lexicography

Resources: A product/service available through the present invention.
Resource Account: The products/services reach the customers by utilizing the resource accounts.
Users: Consumers who wish to utilize a product/service through the present invention.
User Account: The customers utilize the user accounts in order to connect to the products/services.
Previously-Registered Accounts: A plurality of accounts that have been already registered on the present invention.
Social Media Accounts: A plurality of users within a social network.
Mutual Accounts: A plurality of accounts that is mutual to both the plurality of social media accounts and the previously-registered user accounts.
Non-Mutual Accounts: A plurality of accounts that is not mutual to both plurality of social media account and the previously-registered user accounts.
Administrator Account: An account designated to execute the authentication process.

All illustrations of the drawings are for the purpose of describing selected versions of the present invention and are not intended to limit the scope of the present invention.

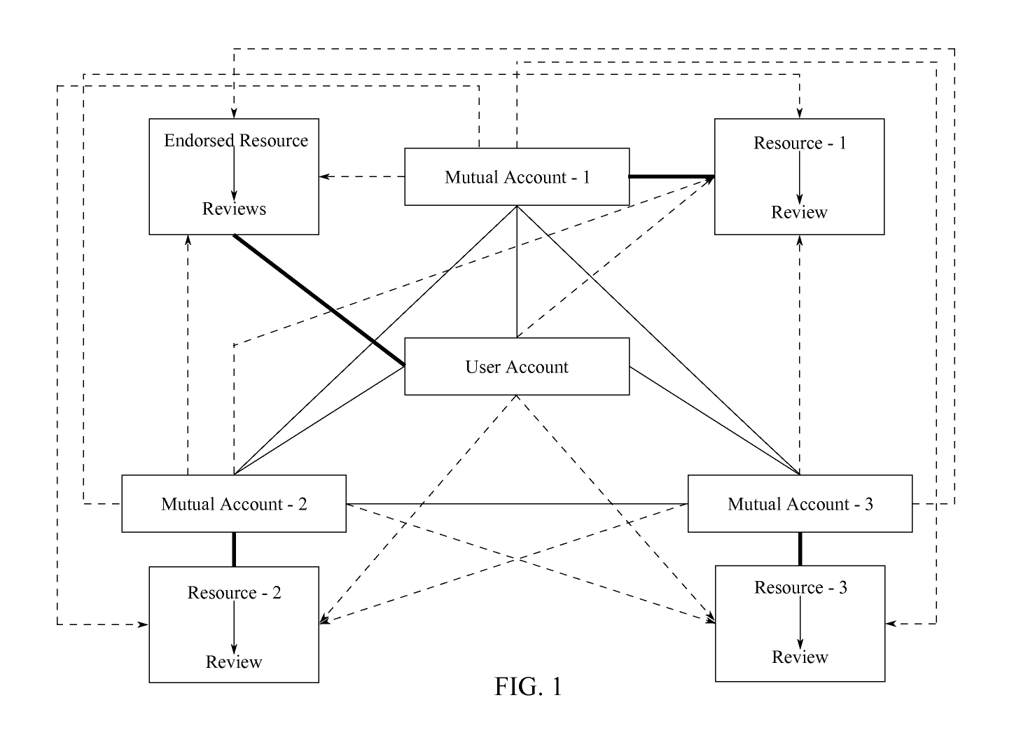

As illustrated in FIG. 1, the present invention is a system and method for sharing resources through a natively created social network or, sharing resources by leveraging an existing social media network. The present invention is focused on serving two primary requirements. First, the existing social media networks are leveraged in order to share information regarding various resources. The resources can be, but is not limited to, services and products. As a result of utilizing existing social media networks, a user is allowed to view reviews, comments, and ratings made by trustworthy individuals. Similarly, the user can view, comment, and rate products and services that are available through the existing social media networks and other products and services made available through the present invention. Depending on the feedback of these trustworthy individuals, the user can get a good idea of the product or service prior to purchase. For instance, if the user intends on selecting a local small business service, the user can first browse the feedback given by trustworthy individuals on the particular local small business service prior to selection. Second, the present invention brings the service provider and the customer onto a common platform. As a result, the service provider and the customer can directly communicate through the common platform. A direct line of communication is essential in order to maintain a healthy relationship between the service provider and the customer. Additionally, the product/service provider can utilize the direct line of communication as a platform for offerings that can be, but is not limited to, coupons, deals, discounts, and rebates. In general, by utilizing the present invention, the service provider can benefit from a committed and loyal customer base. Similarly, the consumers can benefit from the concept of crowd sourcing.

In the process of sharing resources, the present invention links a user and a service provider through a common platform. In order to do so, the present invention manages a plurality of resource accounts. Each of the plurality of resource accounts is linked to a product or service through the present invention. The products or service linked with the plurality of resource accounts can be, but is not limited to, a small business service provider. More specifically, each of the plurality of resource accounts is associated with description information of a service or product. The description information can include, but is not limited to, name, address, services, and pricing details. The description information is utilized to provide sufficient information for the user who is searching for a specific resource. A plurality of previously-registered accounts is provided to connect to the plurality of resource accounts. The plurality of previously-registered accounts can be created with existing social media account login data or new login information. Each of the plurality of previously-registered accounts is associated with identification data and endorsement data. The identification data allows a second user to recognize the first user or vice versa. The endorsement data allows the second user to get an understanding of the resource accounts that have been endorsed by the first user.

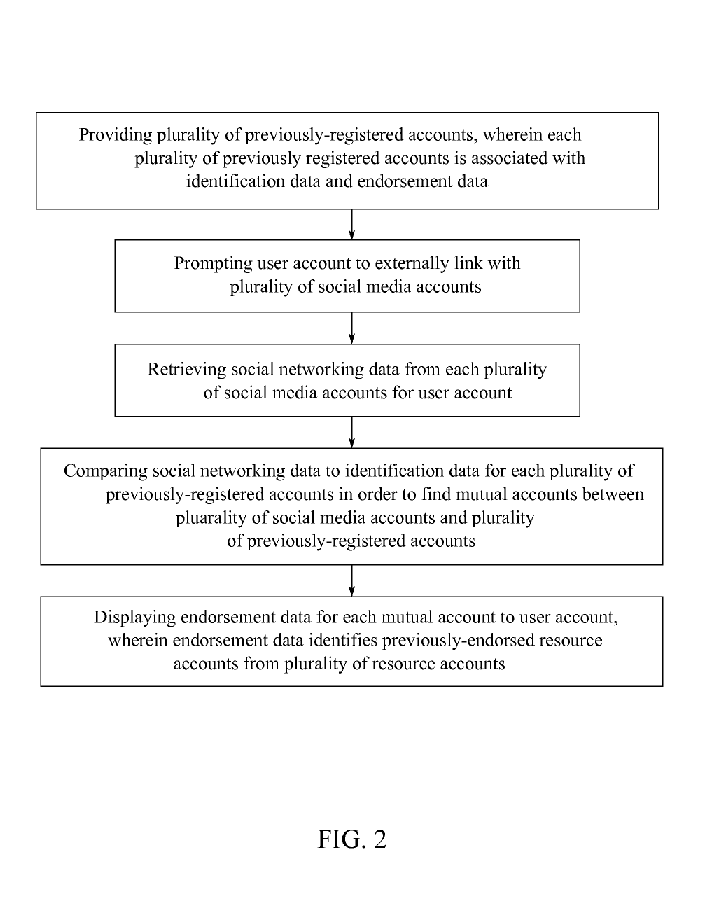

As mentioned previously, a main focus of the present invention is to leverage upon an existing social media network. In order to do, the present invention prompts a user account to externally link with a plurality of social media accounts as illustrated in FIG. 2. The plurality of social media accounts is used to create an expanded network for the user account within the present invention. More specifically, linking to the plurality of social media accounts, connect the user account to a network of trustworthy users. Once the plurality of social media accounts are linked to the user account, the present invention retrieves social networking data from each of the plurality of social media accounts for the user account. The social networking data can be, but is not limited to, identification data and the number of connected users. When the social networking data is retrieved, the present invention compares the social networking data to the identification data of each of the plurality of previously-registered accounts. The comparison is executed in order to find mutual accounts between the plurality of social media accounts and the plurality of previously-registered accounts. If the social networking data matches the identification data on the plurality of previously-registered accounts, then those social media accounts with the matching data are considered mutual accounts. The present invention utilizes the mutual accounts in order to provide the user account information regarding a certain product or service. More specifically, the endorsement data for each of the mutual accounts are displayed to the user account. The endorsement data identifies previously-endorsed resource accounts from the plurality of resource accounts. Therefore, the user account can make use of the endorsement data to get an understanding of the quality of the service provided by the previously-endorsed resource accounts. Since the endorsement data regarding the previously-endorsed resource accounts is provided through the mutual accounts, the user account is guaranteed to receive correct information from trustworthy individuals. Consequently, the consumer accessing the user account is able to feel more comfortable buying products/service that has been endorsed by friends and acquaintances on their social networks.

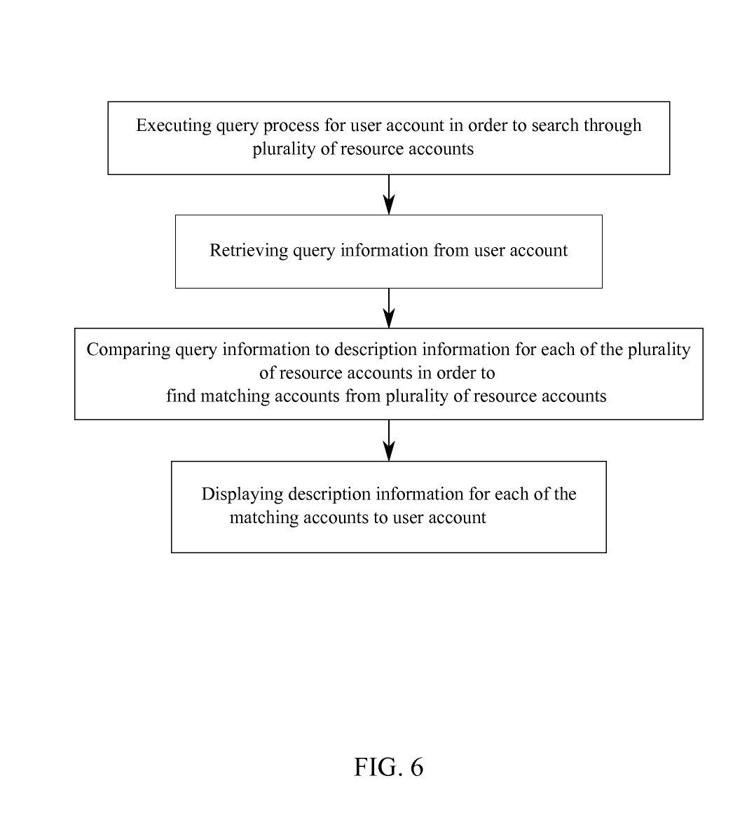

Even though the mutual accounts can link to a variety of resource accounts, it is not guaranteed to include all resource accounts that are relevant to the user account. In order to resolve this issue, the present invention also allows the user account to initiate a query process for at least one specific resource account. When the query process is initiated, the present invention searches for the specific resource account from the plurality of resource accounts as illustrated in FIG. 6. In doing so, the present invention first retrieves query information from the user account. Retrieving query information aids in the process of searching for the closest result that can relate to the specific resource account. The present invention compares the query information to the description information of each of the plurality of resource accounts. The comparison between the query information and the description information is executed to find matching accounts from the plurality of resource accounts. When matching resource accounts are found, the present invention displays the description information for each of the matching accounts to the user account. The matching accounts will be displayed according to the Internet Protocol (IP) address of the user account. More specifically, the matching accounts will be displayed according to the location of the user account. When the present invention is utilized on a smart-phone device, the location of the user account is identified from the Global Positioning System (GPS) coordinates. Furthermore, the present invention searches for the matching accounts within the endorsement data for each of the mutual accounts. As a result, the present invention can determine a subset of the matching accounts that have been already endorsed by the mutual accounts. Displaying the subset of matching accounts endorsed by the mutual accounts helps the user account get more information prior to utilizing a product/service.

The matching accounts are also displayed in a categorically organized manner for user convenience. Therefore, the user account has the ability to decide on the most relevant matching resource account from the displayed matching information. For instance, the user account can choose the most relevant resource according to the location. Furthermore, the user account can gather information regarding the most recently used resources from the description information. Ultimately, the present invention helps in boosting the local economy by promoting local small business services.

In general, the matching accounts for the specific resource account will be based on the physical location of the consumer. As a result, the user account can decide on the most ideal matching account that can be utilized. The most ideal matching account would be chosen based on factors such as location proximity and user accessibility.

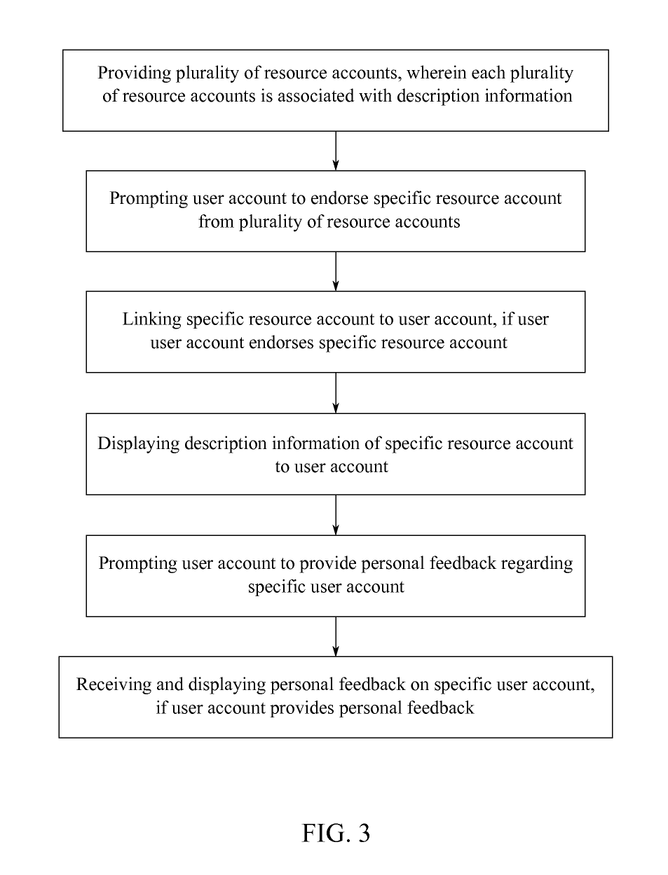

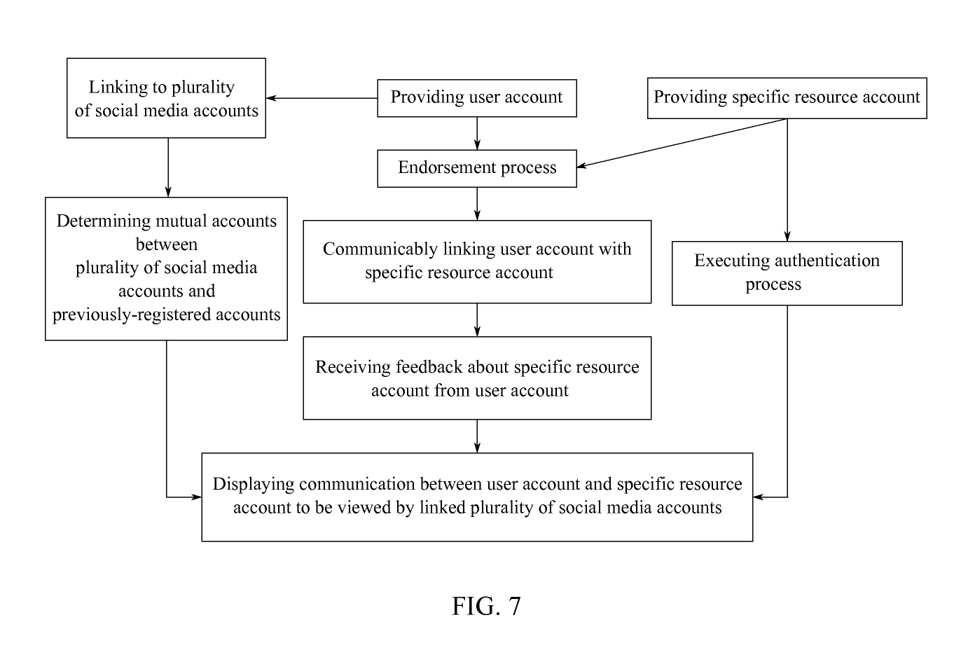

If the user account wishes to further establish a line of communication with the specific resource account, the user account needs to endorse the specific resource account when prompted by the present invention. FIG. 3 and FIG. 7 illustrate the user account endorsing the specific resource account. If the specific resource account is endorsed, the present invention links the specific resource account to the user account. As a result, the specific resource account will be displayed on the user account as an endorsed resource account. Furthermore, the mutual accounts connected to the user account, can also view that the specific resource account as to being endorsed by the user account.

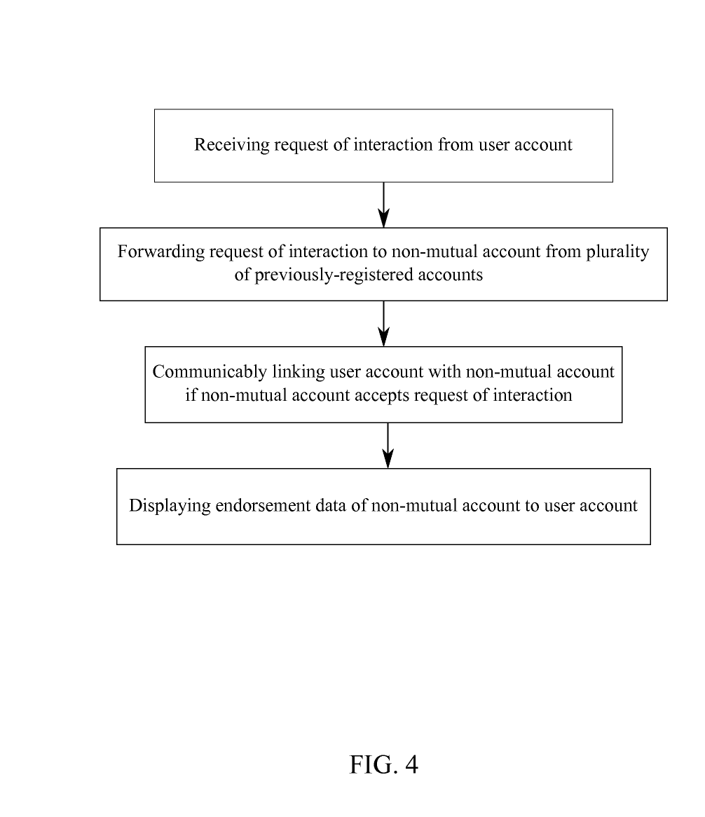

As previously mentioned, the present invention is intended to expand on an existing social media network. However, the present invention also allows the user account to expand the existing network by connecting to a non-mutual account as illustrated in FIG. 4. In the process of doing so, the present invention receives a request of interaction from the user account. Upon receiving the request of interaction, the present invention forwards the request of interaction to the non-mutual account from the plurality of previously registered accounts. The request of interaction serves as a notification to the non-mutual account that the user account is attempting to connect to the non-mutual account. When the request of interaction is received, the non-mutual account has the ability to decide if a connection needs to be established or not. If the non-mutual account decides to accept the request of interaction, the present invention communicably links the user account with the non-mutual account. If the non-mutual account does not accept the request of interaction, the user account is unable to view the resources endorsed by the non-mutual account. As a result of the newly established connection, the endorsement data of the non-mutual account is displayed to the user account. Similarly, the endorsement data of the user account will also be displayed to the non-mutual account since the user account and the non-mutual account are now communicably linked by the present invention.

One of the main focuses of the present invention is to obtain information regarding a certain resource. In order to do so, the present invention allows the user account to view and provide internal feedback content as endorsement data for each of the plurality of resource accounts. The internal feedback content can be, but is not limited to, reviews, rating, and comments. The internal feedback content can be used to provide more information regarding the product and service and is provided by the plurality of previously-registered accounts. Therefore, if internal feedback content is provided about the specific resource account, the present invention displays the internal feedback content to the user account when visiting the specific resource account. From the displayed internal feedback content, the user account has the ability to identify the internal feedback content that has been provided by the mutual accounts. As a result, the user account can be assured to have trustworthy information regarding the specific resource account.

Since there are a large number of resources, each of the plurality of resources cannot be guaranteed to have feedback from the plurality of previously-registered accounts. In order to resolve the issue, the present invention is equipped with the ability to display external feedback content from designated websites for each of the plurality of resource accounts. In order to complete the process, the present invention crawls and retrieves the designated public websites for the external feedback regarding the specific resource account. When necessary external feedback is received for the specific resource account, the external feedback content and the internal feedback content is displayed to the user account. As a result, the user account gets a better understanding of the resource available through the specific resource account.

Similar to viewing internal feedback content provided by the plurality of previously-registered accounts, the user account can also provide personal feedback about the specific resource account which has already been endorsed. In order to do so, the present invention receives personal feedback regarding the specific resource account from the user account. The personal feedback can be both positive and negative and can be, but is not limited to, a comment, a review, or a rating. When received, the present invention displays the personal feedback on the specific resource account. As a result, the user account and the mutual accounts can both view the personal feedback on the specific resource account.

A main focus of the present invention is to promote one-to-one communication between the service provider and the customer. In order to fulfill the requirement, a closed line of communication needs to be established between the customer and the service provider. As mentioned earlier, the user account can directly post personal feedback on the specific resource account that has been already endorsed. However, the specific resource account can communicate with the user account only if the specific resource account is verified by an authentication process.

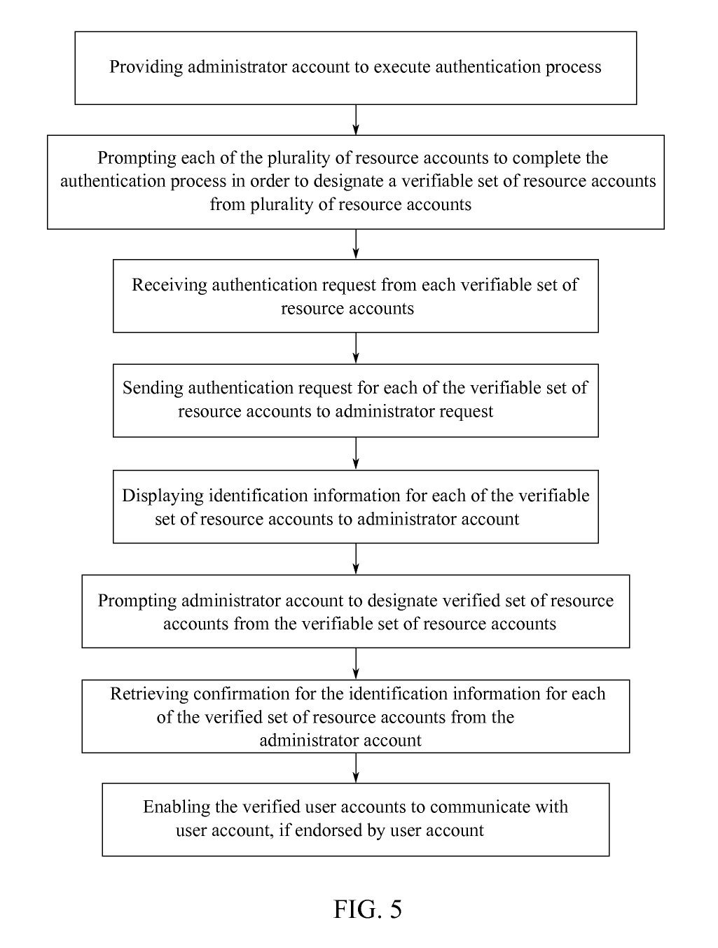

The authentication process is executed in order to verify the validity of each of the plurality of resource accounts and prevents any counterfeit resource accounts from communicating with the plurality of previously-registered accounts. The overall process of the authentication process is illustrated in FIG. 5. In one embodiment the present invention grants access to an administrator through an administrator account. First, the present invention prompts each of the plurality of resource accounts to complete the authentication process in order to designate a verifiable set of resource accounts from the plurality of resource accounts. For clarification purposes, consider a new resource account. The present invention allows the new resource account to be created on a database. The new resource account will remain on the database as an unverified resource account until the authentication process is completed. However, the plurality of previously-registered accounts can still endorse the new resource account. If each of the verifiable set of resource accounts participates in the authentication process, the present invention will receive an authentication request from each of the verifiable set of resource accounts. Upon receiving the authentication request, the present invention sends the authentication request for each of the verifiable set of resource accounts to the administrator account. Next, the administrator determines if the displayed identification information for each of the verifiable set of resource accounts is legitimate. Depending on the decision of the administrator, the present invention prompts the administrator account to designate a verified set of resource accounts from the verifiable set of resource accounts. When designated, the present invention retrieves a confirmation for the identification information for each of the verified set of resource accounts from the administrator account. Upon authentication, the present invention enables communication between the user account and the specific resource account.

In a second embodiment of the present invention, the authentication process can be executed by an automated service. Similar to the first embodiment, each of the plurality of resource accounts is prompted to complete the authentication process. In order to complete the authentication process, the verifiable set of resource accounts is designated from the plurality of resource accounts. Next, the present invention receives the authentication request from each of the verifiable set of resource accounts. Afterwards, the identification information for each of the verifiable set of resource accounts is forwarded to the automated service. The forwarded identification information serves as an input for the automated service. Upon receiving the identification information, the automated service designates the verified set of resource accounts from the verifiable set of resource accounts. Finally, the present invention retrieves confirmation for the identification information for each of the verified set of resource accounts from the automated service.

As mentioned previously, it is beneficial for both parties to have a healthy relationship between the customer and the service provider. Direct communication between the two parties is vital for a healthy relationship. In order to do so, the present invention prompts the user account to directly send an initial message to the specific resource account. The initial message can include, but is not limited to, information regarding the services provided by the specific resource account. The present invention receives and displays the initial message to the specific resource account which allows the specific resource account to determine a reply message. When prompted, the specific resource account directly sends the reply message to the user account. As a final step, the present invention displays the reply message to the user account. A similar procedure can be followed if the specific resource account initiates the line of communication. In such instances, the present invention will receive the initial message from the specific resource account. Next, the initial message will be displayed to the user account who responds with the reply message. Next, the reply message is received by the present invention and displayed to the specific resource account. The ability to contact the user account is especially important for the specific resource account for promotional purposes.

Although the invention has been explained in relation to its preferred embodiment, it is to be understood that many other possible modifications and variations can be made without departing from the spirit and scope of the invention as hereinafter claimed.

What is claimed is:

1. A software system for viewing trusted reviews from social networking peers on an electronic device by executing computer-executable instructions stored on a non-transitory computer-readable medium, the method comprises the steps of:
providing a plurality of resource accounts, wherein each of the plurality of resource accounts is associated with description information;
providing a plurality of previously-registered accounts, wherein each of the plurality of previously-registered accounts is associated with identification data and endorsement data;
prompting a user account to externally link with a plurality of social media accounts;
retrieving social networking data from each of the plurality of social media accounts for the user account;
comparing social networking data to the identification data for each of the plurality of previously-registered accounts in order to find mutual accounts between the plurality of social media accounts and the plurality of previously-registered accounts;
displaying the endorsement data for each of the mutual accounts to the user account, wherein the endorsement data identifies previously-endorsed resource accounts from the plurality of resource accounts;
executing a query process for the user account in order to search through the plurality of resource accounts;
prompting the user account to endorse at least one specific resource account from the plurality of resource accounts;
linking the specific resource account to the user account,
if the user account endorses the specific resource account;
executing an authentication process for each of the plurality of resource accounts; and
enabling communication between the user account and the specific resource account,
if the specific resource account is verified by the authentication process.

2. The software system for viewing trusted reviews from social networking peers on an electronic device by executing computer-executable instructions stored on a non-transitory computer-readable medium, the method as claimed in claim 1 further comprises the steps of:
retrieving query information from the user account;
comparing the query information to the description information for each of the plurality of resource accounts in order to find matching accounts from the plurality of resource accounts; and
displaying the description information for each of the matching accounts to the user account.

3. The software system for viewing trusted reviews from social networking peers on an electronic device by executing computer-executable instructions stored on a non-transitory computer-readable medium, the method as claimed in claim 2 further comprises the steps of:
searching for the matching accounts within the endorsement data for each of the mutual accounts in order to determine a subset of matching accounts endorsed by the mutual accounts; and
displaying the subset of matching accounts endorsed by the mutual accounts to the user account.

4. The software system for viewing trusted reviews from social networking peers on an electronic device by executing computer-executable instructions stored on a non-transitory computer-readable medium, the method as claimed in claim 1 further comprises the steps of:
receiving a request of interaction from the user account;
forwarding the request of interaction to a non-mutual account from the plurality of previously-registered accounts;
communicably linking the user account with the non-mutual account,
if the non-mutual account accepts the request of interaction; and
displaying the endorsement data of the non-mutual account to the user account.

5. The software system for viewing trusted reviews from social networking peers on an electronic device by executing computer-executable instructions stored on a non-transitory computer-readable medium, the method as claimed in claim 1 further comprises the steps of:
providing internal feedback content as the endorsement data for each of the plurality of resource accounts, wherein feedback content is submitted by the plurality of previously-registered accounts; and
displaying the internal feedback content of the specific resource account to the user account.

6. The software system for viewing trusted reviews from social networking peers on an electronic device by executing computer-executable instructions stored on a non-transitory computer-readable medium, the method as claimed in claim 1 further comprises the steps of:
providing internal feedback content as the endorsement data for each of the plurality of resource accounts, wherein feedback content is submitted by the plurality of previously-registered accounts;
receiving personal feedback about the specific resource account from the user account; and
displaying the personal feedback with the internal feedback content for the specific resource account to the user account.

7. The software system for viewing trusted reviews from social networking peers on an electronic device by executing computer-executable instructions stored on a non-transitory computer-readable medium, the method as claimed in claim 1 further comprises the steps of:
providing internal feedback content as the endorsement data for each of the plurality of resources accounts, wherein feedback content is submitted by the plurality of previously-registered accounts;
providing designated websites with external feedback content for each of the plurality of resource accounts;
crawling and retrieving the designated websites for the external feedback content for the specific resource account; and
displaying the external feedback content with the internal feedback content for the specific resource account to the user account.

8. The software system for viewing trusted reviews from social networking peers on an electronic device by executing computer-executable instructions stored on a non-transitory computer-readable medium, the method as claimed in claim 1 further comprises the steps of:
prompting the user account to directly send an initial message to the specific resource account;
receiving and displaying the initial message to the specific resource account;
prompting the specific resource account to directly send a reply message to the specific resource account; and
receiving and displaying the reply message to the user account.

9. The software system for viewing trusted reviews from social networking peers on an electronic device by executing computer-executable instructions stored on a non-transitory computer-readable medium, the method as claimed in claim 1 further comprises the steps of:
prompting the specific resource account to directly send an initial message to the specific resource account;
receiving and displaying the initial message to the specific resource account;
prompting the user account to directly send a reply message to the specific resource account; and
receiving and displaying the reply message to the specific resource account.

10. The software system for viewing trusted reviews from social networking peers on an electronic device by executing computer-executable instructions stored on a non-transitory computer-readable medium, the method as claimed in claim 1 further comprises the steps of:
providing an administrator account in order to execute the authentication process;
prompting each of the plurality of resource accounts to complete the authentication process in order to designate a verifiable set of resource accounts from the plurality of resource accounts;
receiving an authentication request from each of the verifiable set of resource accounts;
sending the authentication request for each of the verifiable set of resource accounts to the administrator account;
displaying the identification information for each of the verifiable set of resource accounts to the administrator account;
prompting the administrator account to designate a verified set of resource accounts from the verifiable set of resource accounts; and
retrieving a confirmation for the identification information for each of the verified set of resource accounts from the administrator account.

11. The software system for viewing trusted reviews from social networking peers on an electronic device by executing computer-executable instructions stored on a non-transitory computer-readable medium, the method as claimed in claim 1 further comprises the steps of:
providing an automated service to execute the authentication process;
prompting each of the plurality of resource accounts to complete the authentication process in order to designate a verifiable set of resource accounts from the plurality of resource accounts;
receiving an authentication request from each of the verifiable set of resource accounts;
inputting the identification information for each of the verifiable set of resource accounts into the automated service, wherein the automated service analyzes the identification information and designates a verified set of resource accounts from the verifiable set of resource accounts; and
retrieving a confirmation for the identification information for each of the verified set of resource accounts from the automated service.
